(19) United States
(12) Patent Application Publication
(10) Pub. No.: US 2020/0130691 A1
(43) Pub. Date: Apr. 30, 2020

(54) INFORMATION PROCESSING DEVICE, NON-TRANSITORY STORAGE MEDIUM IN WHICH PROGRAM IS RECORDED, AND INFORMATION PROCESSING METHOD

(71) Applicant: TOYOTA JIDOSHA KABUSHIKI KAISHA, Toyota-shi (JP)

(72) Inventor: Naoto SASAGAWA, Nishio-shi (JP)

(73) Assignee: TOYOTA JIDOSHA KABUSHIKI KAISHA, Toyota-shi (JP)

(21) Appl. No.: 16/515,623

(22) Filed: Jul. 18, 2019

(30) Foreign Application Priority Data
Oct. 31, 2018 (JP) 2018-205123

(51) Int. Cl. B60W 30/18; H04L 29/08; G08G 1/01

(52) U.S. Cl. CPC B60W 30/18; H04L 67/12; B60W 2550/20; G08G 1/0112; G08G 1/0125

(57) ABSTRACT

An information processing device, a non-transitory storage medium in which a program is recorded, and an information processing method are disclosed. The information processing device includes: an acquisition unit configured to acquire information from a decision-target vehicle; and a control unit configured to give a manner point to the decision-target vehicle which provides the information, based on an other-object reaction and an other-object influence action, when it is determined that an action of the decision-target vehicle is the other-object influence action based on the acquired information, the other-object influence action being an action that influences another object, the other-object reaction being a reaction of the other object to the other-object influence action and being checked based on information about a periphery of the decision-target vehicle.

### INCORPORATION BY REFERENCE

The disclosure of Japanese Patent Application No. 2018-205123 filed on Oct. 31, 2018 including the specification, drawings and abstract is incorporated herein by reference in its entirety.

### BACKGROUND

### 1. Technical Field

The disclosure relates to an information processing device, a non-transitory storage medium in which a program is recorded, and an information processing method.

### 2. Description of Related Art

A technology for improving driving manners of a vehicle has been studied. For example, Japanese Patent Application Publication No. 2015-108854 discloses that a manner point is given depending on a driving situation and peripheral situation of the vehicle and a service is provided depending on the manner point.

### SUMMARY

An information processing system according to Japanese Patent Application Publication No. 2015-108854 estimates an action of the vehicle and decides whether the manner of the action is good, based on combination of the driving situation and peripheral situation of the vehicle. However, in some cases, the estimated action does not actually cause smooth traffic. Hence, for a technology of encouraging execution of particularly desired driving manners that actually causes smooth traffic, there is room for improvement.

The disclosure provides a technology of encouraging the execution of particularly desired driving manners.

A first aspect of the disclosure provides an information processing device including: an acquisition unit configured to acquire information from a decision-target vehicle; and a control unit configured to give a manner point to the decision-target vehicle which provides the information, based on an other-object reaction and an other-object influence action, when it is determined that an action of the decision-target vehicle is the other-object influence action based on the acquired information, the other-object influence action being an action that influences another object, the other-object reaction being a reaction of the other object to the other-object influence action and being checked based on information about a periphery of the decision-target vehicle.

In the first aspect, the acquisition unit may be configured to acquire detection information detected by a sensor of a vehicle; and the control unit may be configured to estimate the action of the decision-target vehicle based on the detection information, and to determine whether the estimated action is the other-object influence action of the decision-target vehicle.

In the above configuration, the control unit may be configured to, when it is determined that the action of the decision-target vehicle is the other-object influence action, check the other-object reaction, using detection information acquired from the decision-target vehicle as the information about the periphery.

In the above aspect, the control unit may be configured to, when it is determined that the action of the decision-target vehicle is the other-object influence action and the other object influenced by the other-object influence action is a vehicle, check the other-object reaction, using detection information acquired from the vehicle being the other object, as the information about the periphery.

In the first aspect, the control unit may be configured to, when it is determined that the other-object influence action of the decision-target vehicle is a favorable other-object influence action and the other object influenced by the other-object influence action is a vehicle, request an acknowledgment of the other-object influence action, to the vehicle being the other object.

In the above configuration, the control unit may be configured to check the other-object reaction, using the acknowledgment of the other-object influence action as the information about the periphery, the acknowledgment of the other-object influence action being acquired from the vehicle to which the control unit requests the acknowledgment of the other-object influence action.

In the above configuration, the control unit may be configured to, when the control unit acquires the acknowledgment of the other-object influence action from the vehicle to which the control unit requests the acknowledgment of the other-object influence action, give the manner point to the vehicle.

In the first aspect, the control unit may be configured to, when the action of the decision-target vehicle is determined to be the other-object influence action and the control unit is not able to check the other-object reaction, give a manner point lower than a manner point that is given based on the other-object influence action and the other-object reaction, to the decision-target vehicle.

In the first aspect, the control unit may be configured to, when it is determined that the action of the decision-target vehicle is an action other than the other-object influence action and is a manner action relevant to a driving manner of the decision-target vehicle, give a manner point lower than a manner point that is given based on the other-object influence action and the checked other-object reaction, to the decision-target vehicle.

In the first aspect, the control unit may be configured to, when the other-object reaction indicates affirmation of the other-object influence action, give a positive manner point.

In the first aspect, the control unit may be configured to, when the other-object reaction indicates negation of the other-object influence action, give a negative manner point.

In the first aspect, the acquisition unit may be configured to acquire execution information indicating that the decision-target vehicle is executing the other-object influence action, and the control unit may be configured to determine that the action of the decision-target vehicle is the other-object influence action, based on the execution information.

A second aspect of the disclosure provides a non-transitory storage medium in which a program is recorded. When the program is executed by an information processing device, the program causes the information processing device to execute: acquiring information from a decision-target vehicle; checking an other-object reaction based on information about a periphery of the decision-target vehicle, when it is determined that an action of the decision-target vehicle is an other-object influence action based on the acquired information, the other-object influence action being an action that influences another object, the other-object reaction being a reaction of the other object to the other-object influence action; and giving a manner point to the decision-target vehicle based on the other-object influence action and the other-object reaction.

A third aspect of the disclosure provides an information processing method including: acquiring information from a decision-target vehicle; checking an other-object reaction based on information about a periphery of the decision-target vehicle, when it is determined that an action of the decision-target vehicle is an other-object influence action based on the acquired information, the other-object influence action being an action that influences another object, the other-object reaction being a reaction of the other object to the other-object influence action; and giving a manner point to the decision-target vehicle based on the other-object influence action and the other-object reaction.

The above aspect improves the technology of encouraging the execution of particularly desired driving manners.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a configuration diagram showing an overall configuration of an information processing system including an information processing device according to an embodiment of the disclosure;

FIG. 2 is a functional block diagram showing a schematic configuration of a vehicle in FIG. 1;

FIG. 3 is a functional block diagram showing a schematic configuration of the information processing device in FIG. 1;

FIG. 4 is a flowchart for describing a detection information giving process that is executed by a control unit in FIG. 2;

FIG. 5 is a flowchart for describing an execution information giving process that is executed by the control unit in FIG. 2;

FIG. 6 is a flowchart for describing a storage process that is executed by a control unit in FIG. 3; and

FIG. 7 is a flowchart for describing a point giving process that is executed by the control unit in FIG. 3.

### DETAILED DESCRIPTION OF EMBODIMENTS

Hereinafter, an embodiment of the disclosure will be described with reference to the drawings.

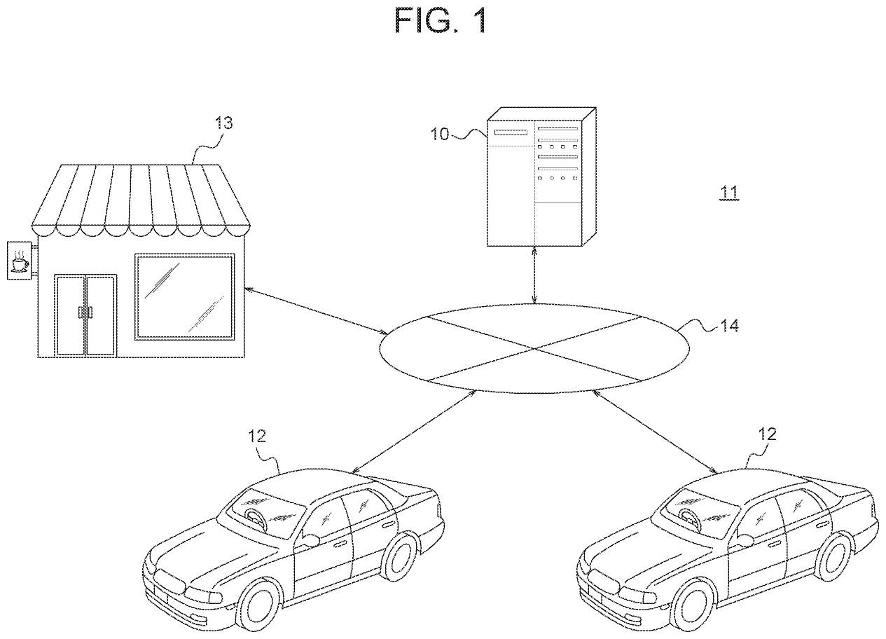

An outline of an information processing system 11 including an information processing device 10 according to an embodiment of the disclosure will be described with reference to FIG. 1. The information processing system 11 includes vehicles 12, an information processing device 10 and a shop terminal 13. Each of the vehicles 12 is an automobile, for example, but may be an arbitrary vehicle, without being limited to the automobile. The shop terminal 13 is an operation terminal to provide a function of a shop that performs at least one of sale of particular products and provision of particular services. The shop terminal 13 is a general-purpose electronic device such as a smartphone or a personal computer (PC), for example, but may be a dedicated electronic device for the information processing system 11, without being limited to the general-purpose electronic device. The shop may be a real shop or may be a virtual shop on the internet. For a simple description, two vehicles 12 and one shop terminal 13 are illustrated in FIG. 1. However, in the information processing system 11, each of the number of vehicles 12 and the number of shop terminals 13 only needs to be one or more. The information processing device 10, for example, includes one server device or a plurality of server devices that can communicate with each other. Each of the vehicles 12, the information processing device 10 and the shop terminal 13 is connected to a network 14 including, for example, a mobile communication network and the internet, in a communicable fashion.

Each of the vehicles 12 gives information about the own vehicle 12, to the information processing device 10. In the case where the information processing device 10 determines that an action of the vehicle 12 is an other-object influence action based on the acquired information, the information processing device 10 determines whether information about the periphery of the vehicle 12 has been acquired. In the case where the information about the periphery has been acquired, the information processing device 10 checks an other-object reaction to the other-object influence action, based on the information about the periphery. The information processing device 10 decides a manner point based on the other-object influence action and the other-object reaction, and gives the manner point to the vehicle 12. After the manner point is given, the vehicle 12, in the shop terminal 13, can enjoy a benefit in a receipt of a product or service set in the shop terminal 13, based on the manner point.

Thus, in the embodiment, the manner point is given to the vehicle 12 that has performed the other-object influence action appreciated by another object. Using the given manner point, the vehicle 12 can enjoy various benefits in the shop terminal 13.

Thereby, an incentive to perform the other-object influence action appreciated by the other object is given to a driver of the vehicle 12, and therefore, the driver is encouraged to execute particularly desired driving manners. As a result, a technology of encouraging the execution of particularly desired driving manners is improved.

Next, each constituent of the information processing system 11 will be described in detail.

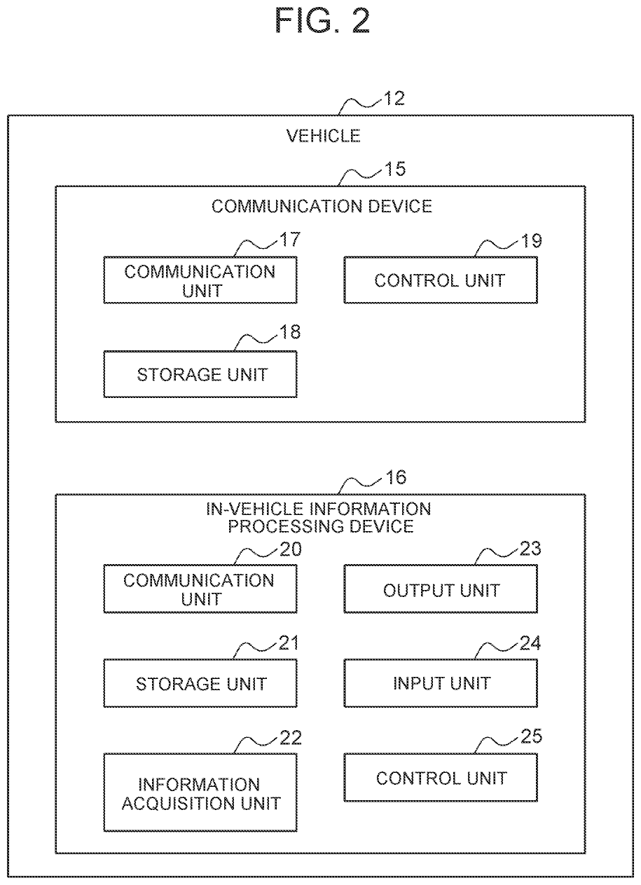

As shown in FIG. 2, the vehicle 12 includes a communication device 15 and an in-vehicle information processing device 16. The communication device 15 and the in-vehicle information processing device 16 are connected to each other in a communicable fashion, for example, through an in-vehicle network such as a controller area network (CAN), or a dedicated line.

The communication device 15 is an in-vehicle communication instrument such as a data communication module (DCM), for example. Specifically, the communication device 15 includes a communication unit 17, a storage unit 18 and a control unit 19.

The communication unit 17 includes a communication module that communicates through the in-vehicle network or the dedicated line. Further, the communication unit 17 includes a communication module that is connected to the network 14. For example, the communication unit 17 may include a communication module that supports mobile communication standards such as 4th generation (4G) and 5th generation (5G). In the embodiment, the vehicle 12 is connected to the network 14 through the communication unit 17.

The storage unit 18 includes one or more memories. In the embodiment, the “memory” is a semiconductor memory, a magnetic memory, or an optical memory, for example, but is not limited to them. Each memory included in the storage unit 18 may function as a main storage device, an auxiliary storage device or a cache memory, for example. The storage unit 18 stores arbitrary information that is used for operation of the communication device 15. For example, the storage unit 18 may store system programs, application programs, identification information of the vehicle 12, and the like. The identification information of the vehicle 12 is information allowing the information processing system 11 to unambiguously identify each of the vehicles 12.

When information is sent from the communication device 15 to the information processing device 10, together with the information, the identification information of the vehicle 12 is given to the information processing device 10, and thereby, the information processing device 10 can identify the vehicle 12 that is a giving source. Here, identification information of the communication device 15 or in-vehicle information processing device 16 included in the vehicle 12 may be used as the identification information of the vehicle 12. The information stored in the storage unit 18 may be updatable to information that is acquired from the network 14 through the communication unit 17, for example.

The control unit 19 includes one or more processors. In the embodiment, the “processor” is a general-purpose processor or a dedicated processor for a particular process, but is not limited to them. The control unit 19 controls operation of the whole of the communication device 15. In the embodiment, the vehicle 12 communicates with the information processing device 10 and the shop terminal 13, through the communication device 15 that is controlled by the control unit 19. The vehicle 12 acquires and gives information, commands and the like, by the communication with the information processing device 10 and the shop terminal 13.

The in-vehicle information processing device 16 is a device that manages a variety of information about the vehicle 12. For example, the in-vehicle information processing device 16 collects a variety of detection information about the vehicle 12, which will be described later. The in-vehicle information processing device 16, as necessary, gives the collected detection information to the information processing device 10 through the communication device 15, without processing the detection information or after processing the detection information. The in-vehicle information processing device 16 includes a communication unit 20, a storage unit 21, an information acquisition unit 22, an output unit 23, an input unit 24 and a control unit 25.

The communication unit 20 includes a communication module that communicates through the in-vehicle network or the dedicated line.

The storage unit 21 includes one or more memories. Each memory included in the storage unit 21 may function as a main storage device, an auxiliary storage device or a cache memory, for example. The storage unit 21 stores arbitrary information that is used for operation of the in-vehicle information processing device 16. For example, the storage unit 21 may store system programs, application programs, road map information, manner point information described later, and the like. The information stored in the storage unit 21 may be updatable to information that is acquired from the network 14 through the communication device 15, for example.

The information acquisition unit 22 acquires the detection information detected by a variety of sensors mounted on the vehicle 12, directly or through an electronic control unit (ECU). Examples of the detection information include braking information, high-low switching information, speed information, acceleration information, image information, direction indicator information, steering information, distance information, time information, position information, hazard information, illuminance information and head lamp information.

The braking information, for example, indicates a stepping amount of a brake pedal that is detected by a brake pedal sensor. The high-low switching information, for example, indicates information of a high-low switching instruction that is detected by a head lamp switching lever sensor. The speed information, for example, indicates the speed of the vehicle 12 that is detected by a speed sensor. The acceleration information, for example, indicates the acceleration of the vehicle 12 that is detected by an acceleration sensor. The image information, for example, indicates an image that is obtained by picking up the periphery of the vehicle 12 and that is detected by an in-vehicle camera. The direction indicator information, for example, indicates information of a blinking instruction for a direction indicator that is detected by a direction indicator lever sensor. The steering information, for example, indicates a turning amount of a steering wheel that is detected by a steering angle sensor. The distance information, for example, indicates the distance from the other object that is detected by a clearance sonar. The time information, for example, indicates a time that is detected by a timer. The position information, for example, indicates the position of the vehicle 12 on a map that is detected by a global positioning system (GPS) receiver or the like. The hazard information, for example, indicates information of a hazard lamp blinking instruction that is detected by operation of a hazard lamp switch. The illuminance information, for example, is the illuminance of the exterior of the vehicle 12 that is detected by an illuminance sensor. The head lamp information, for example, indicates information of a head lamp lighting instruction that is detected by operation of a head lamp switch.

The output unit 23 includes one or more output interfaces that output information and give notice to a user. For example, each output interface included in the output unit 23 is a display that outputs the information as a picture, a speaker that outputs the information as a voice, or the like, but is not limited to them. For example, the display is a panel display, a head-up display or the like, but is not limited to them. In the embodiment, the “picture” may include a text, a still image and a moving image.

The input unit 24 includes one or more input interfaces that detect a user input. For example, the input interface included in the input unit 24 is a physical key, an electrostatic capacitance key, a touch screen that is provided integrally with the panel display of the output unit 23, or a microphone that detects a voice input, but is not limited to them.

The control unit 25 includes one or more processors. The control unit 25 controls operation of the whole of the in-vehicle information processing device 16.

For example, the control unit 25 temporarily stores, in the storage unit 21, a plurality of pieces of detection information acquired in the information acquisition unit 22 at the same time, in association with each other. For example, the same time is a period after an arbitrary time of a cyclic detection by the timer and before a time of the next discrete detection. Furthermore, the control unit 25 sends the plurality of pieces of detection information associated with each other, to the information processing device 10 through the communication device 15.

For example, the control unit 25 may generate execution information based on the plurality of pieces of detection information acquired in the information acquisition unit 22 at the same time. For example, the execution information is information indicating that the vehicle 12 is executing the other-object influence action. The other-object influence action is an action that is previously set as an action that influences the other object. The other-object influence action may be automatically learned by machine learning, as the action that influences the other object. After the generation of the execution information, the control unit 25 sends the execution information to the information processing device 10 through the communication device 15.

The other-object influence action may include a favorable other-object influence action that is desired to be executed and an unfavorable other-object influence action that is desired to be avoided. Examples of the favorable other-object influence action include a right-turn yielding action, a crossing allowing action, a lane-change allowing action and a yellow-light stop action. Further, examples of the unfavorable other-object influence action include a mischievous lane-change action, a tailgating-driving action, an aggressive right-turn action, a mischievous slow-traveling action, a mischievous sudden-braking action and a mischievous non-stop action.

The right-turn yielding action is an action in which the own vehicle 12 to go straight stops and flashes the head lamp for a vehicle 12 as the other object that waits diagonally forward of the own vehicle 12 and thereby encourages the other object to turn right. The control unit 25 determines whether there is a vehicle 12 as the other object that waits diagonally forward of the own vehicle 12, based on the image information. Further, for example, the control unit 25 determines whether the own vehicle 12 is in a stop state, based on at least one of the braking information and the speed information. Further, for example, the control unit 25 determines whether the own vehicle 12 is flashing the head lamp, based on the high-low switching information about the head lamp. Furthermore, the control unit 25 estimates whether the own vehicle 12 is performing the right-turn yielding action, based on combination of the determination results. In the case where the own vehicle 12 is performing the right-turn yielding action, the control unit 25 generates the execution information indicating that the own vehicle 12 is executing the right-turn yielding action.

The crossing allowing action is an action in which the vehicle 12 stops at a crosswalk with no traffic light and allows a pedestrian or bicycle at a side of the crosswalk to cross the road. For example, the control unit 25 determines whether the own vehicle 12 is on the near side of a crosswalk with no traffic light, based on the road map information and position information. Further, for example, the control unit 25 determines whether the own vehicle 12 is in the stop state, based on at least one of the braking information and the speed information. Further, the control unit 25 determines whether there is a pedestrian or bicycle at a side of the crosswalk, based on the image information. Furthermore, the control unit 25 estimates whether the own vehicle 12 is performing the crossing allowing action, based on combination of the determination results. In the case where the own vehicle 12 is performing the crossing allowing action, the control unit 25 generates the execution information indicating that the own vehicle 12 is executing the crossing allowing action.

The lane-change allowing action is an action in which the own vehicle 12 during traveling decelerates and flashes the head lamp for the vehicle 12 as the other object that is traveling on an adjacent lane forward of the own vehicle 12 and that wants to perform lane change while blinking the direction indicator, and thereby allows the vehicle 12 as the other object to perform the lane change to the traveling lane of the own vehicle 12. For example, the control unit 25 determines whether the own vehicle 12 is traveling, based on the speed information. Further, for example, the control unit 25 determines whether there is a vehicle 12 as the other object that is traveling on an adjacent lane forward of the own vehicle 12 and that wants to perform the lane change, based on the image information. Further, for example, the control unit 25 determines whether the own vehicle 12 is decelerating, based on at least one of the braking information and the speed information. Further, for example, the control unit 25 determines whether the own vehicle 12 is flashing the head lamp, based on the high-low switching information about the head lamp. Furthermore, the control unit 25 estimates whether the own vehicle 12 is performing the lane-change allowing action, based on combination of the determination results. In the case where the own vehicle 12 is performing the lane-change allowing action, the control unit 25 generates the execution information indicating that the own vehicle 12 is executing the lane-change allowing action.

The yellow-light stop action is an action in which the own vehicle 12 during traveling stops without entering an intersection when a vehicle 12 as the other object waits for a right turn timing diagonally forward of the own vehicle 12 and a traffic light forward of the own vehicle 12 is yellow. For example, the control unit 25 determines whether a vehicle 12 as the other object waits for the right turn timing diagonally forward of the own vehicle 12 and whether the traffic light forward of the own vehicle 12 during traveling is yellow, based on the image information. Further, for example, the control unit 25 determines whether the own vehicle 12 is in the stop state, based on at least one of the braking information and the speed information. Furthermore, the control unit 25 estimates whether the own vehicle 12 is performing the yellow-light stop action, based on combination of the determination results. In the case where the own vehicle 12 is performing the yellow-light stop action, the control unit 25 generates the execution information indicating that the own vehicle 12 is executing the yellow-light stop action.

The mischievous lane-change action is an action in which the own vehicle 12 performs the lane change without blinking the direction indicator at an appropriate timing, in front of a vehicle 12 as the other object that is traveling on an adjacent lane rearward of the own vehicle 12. For example, the control unit 25 determines whether there is a vehicle 12 as the other object that is traveling on an adjacent lane rearward of the own vehicle 12, based on the image information. Further, for example, the control unit 25 determines whether the blinking of the direction indicator has been performed at an appropriate timing, based on the steering information, the direction indicator information and the time information. Furthermore, the control unit 25 estimates whether the own vehicle 12 is performing the mischievous lane-change action, based on combination of the determination results. In the case where the own vehicle 12 is performing the mischievous lane-change action, the control unit 25 generates the execution information indicating that the own vehicle 12 is executing the mischievous lane-change action.

The tailgating-driving action is an action in which the own vehicle 12 continues traveling close to a vehicle 12 as the other object that is traveling on the traveling lane forward of the own vehicle 12, at a speed equal to or higher than an allowable speed with respect to the limiting speed. For example, the allowable speed with respect to the limiting speed is a speed of 90% of the limiting speed. For example, the control unit 25 determines whether there is a vehicle 12 as the other object on the traveling lane forward of the own vehicle 12, based on the image information. Further, the control unit 25 checks the limiting speed of the traveling road, based on the position information and the road map information, and calculates the allowable speed. Further, the control unit 25 determines whether the vehicle 12 as the other object is traveling at a speed equal to or higher than the allowable speed, based on the speed information, the distance information and the time information. Further, the control unit 25 determines whether the own vehicle 12 continues traveling close to the vehicle 12 as the other object, based on the distance information and the time information. For example, the traveling close to the vehicle 12 as the other object means that the interval between the own vehicle 12 and the vehicle 12 as the other object is less than an inter-vehicle distance that is set depending on the speed of the own vehicle 12. Furthermore, the control unit 25 estimates whether the own vehicle 12 is performing the tailgating-driving action, based on combination of the determination results. In the case where the own vehicle 12 is performing the tailgating-driving action, the control unit 25 generates the execution information indicating that the own vehicle 12 is executing the tailgating-driving action.

The aggressive right-turn action is an action in which the own vehicle 12 turns right in a state where there is a vehicle 12 as the other object that is traveling straight on an oncoming lane forward of the own vehicle 12. The control unit 25 determines whether there is a vehicle 12 as the other object that is traveling straight on the oncoming lane forward of the own vehicle 12, based on the image information. Further, for example, the control unit 25 determines whether the own vehicle 12 is turning right, based on the steering information and the speed information. Furthermore, the control unit 25 estimates whether the own vehicle 12 is performing the aggressive right-turn action, based on combination of the determination results. In the case where the own vehicle 12 is performing the aggressive right-turn action, the control unit 25 generates the execution information indicating that the own vehicle 12 is executing the aggressive right-turn action.

The mischievous slow-traveling action is an action in which the own vehicle 12 continues traveling at a speed lower than the allowable speed with respect to the limiting speed in a state where a vehicle 12 as the other object is traveling on the traveling lane of the own vehicle 12 rearward of the own vehicle 12. For example, the control unit 25 determines whether there is a vehicle 12 as the other object that is traveling on the traveling lane of the own vehicle 12 rearward of the own vehicle 12, based on the speed information and the position information. Further, for example, the control unit 25 checks the limiting speed of the traveling road, based on the position information and the road map information, and calculates the allowable speed. For example, the control unit 25 determines whether the own vehicle 12 continues traveling at a speed lower than the allowable speed, based on the calculated allowable speed and the speed information. Furthermore, the control unit 25 estimates whether the own vehicle 12 is performing the mischievous slow-traveling action, based on combination of the determination results. In the case where the own vehicle 12 is performing the mischievous slow-traveling action, the control unit 25 generates the execution information indicating that the own vehicle 12 is executing the mischievous slow-traveling action.

The mischievous sudden-braking action is an action in which the own vehicle 12 suddenly decelerates in a state where a vehicle 12 as the other object is traveling on the traveling lane of the own vehicle 12 rearward of the own vehicle 12. For example, the control unit 25 determines whether there is a vehicle 12 as the other object that is traveling on the traveling lane of the own vehicle 12 rearward of the own vehicle 12, based on the speed information and the position information. Further, the control unit 25 determines whether the own vehicle 12 is suddenly decelerating, based on the braking information or based on the speed information and the time information. Furthermore, the control unit 25 estimates whether the own vehicle 12 is performing the mischievous sudden-braking action, based on combination of the determination results. In the case where the own vehicle 12 is performing the mischievous sudden-braking action, the control unit 25 generates the execution information indicating that the own vehicle 12 is executing the mischievous sudden-braking action.

The mischievous non-stop action is an action in which the own vehicle 12 travels without stopping at a stop line, when a vehicle 12 as the other object travels to an intersection from a road crossing the traveling road of the own vehicle 12 forward of the own vehicle 12. For example, the control unit 25 determines whether the own vehicle 12 goes toward the intersection, based on the position information and the road map information. Further, the control unit 25 determines whether there is a vehicle 12 as the other object that is traveling short of the intersection, based on the distance information or the image information. Further, the control unit 25 determines whether the own vehicle 12 stops at the stop line, based on the position information, the road map information and the speed information. Furthermore, the control unit 25 estimates whether the own vehicle 12 is performing the mischievous non-stop action, based on combination of the determination results. In the case where the own vehicle 12 is performing the mischievous non-stop action, the control unit 25 generates the execution information indicating that the own vehicle 12 is executing the mischievous non-stop action.

For example, the control unit 25 updates the manner point information stored in the storage unit 21, based on the manner point that is given from the information processing device 10. For example, the manner point information indicates a total value and a manner point rank. For example, the total value is the total value of manner points given before now. The manner point rank is a grade that is determined based on the total value. For example, the manner point rank includes Gold that is given when the total value is 1000 points or more, Silver that is given when the total value is 100 points or more and 999 points or less, and Bronze that is given when the total value is 0 points or more and 99 points or less, in the order from the highest rank.

For example, the manner point rank is used for the decision of various benefits in the shop terminal 13. For example, in the case where the shop using the shop terminal 13 is a coffee shop, a sandwich may be provided for free, when the manner point rank of the vehicle 12 is Gold. Further, for example, a cup of coffee may be provided for free, when the manner point rank of the vehicle 12 is Silver. Further, for example, 30 yen may be discounted from a payment amount, when the manner point rank of the vehicle 12 is Bronze.

The control unit 25 reads the manner point information from the storage unit 21, when the product or service set in the shop terminal 13 is received through the communication with the shop terminal 13. Furthermore, the control unit 25 notifies the shop terminal 13 of the manner point information.

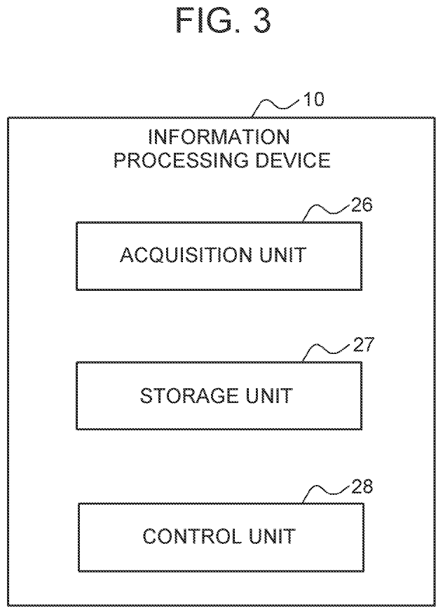

As shown in FIG. 3, the information processing device 10 includes an acquisition unit 26, a storage unit 27 and a control unit 28.

For example, the acquisition unit 26 includes a communication module that is connected to the network 14. For example, the acquisition unit 26 may include a communication module that supports a cable local area network (LAN) standard. In the embodiment, the information processing device 10 is connected to the network 14 through the acquisition unit 26. The acquisition unit 26 acquires information such as the detection information and the execution information, from the vehicle 12. The acquisition unit 26 may give a variety of information and commands to the vehicle 12 and the shop terminal 13.

The storage unit 27 includes one or more memories. Each memory included in the storage unit 27 may function as a main storage device, an auxiliary storage device or a cache memory, for example. The storage unit 27 stores arbitrary information that is used for operation of the information processing device 10. For example, the storage unit 27 may store system programs and application programs. For example, the storage unit 27 may store the other-object influence action, the combination of the other-object influence action and other-object evaluation, the manner point given for a manner action, and the total value of manner points of each vehicle 12. For example, the information stored in the storage unit 27 may be updatable to information that is acquired from the network 14 through the acquisition unit 26.

The control unit 28 includes one or more processors. The control unit 28 controls operation of the whole of the information processing device 10.

For example, the control unit 28 determines whether the action of the decision-target vehicle is the other-object influence action, based on the detection information or execution information acquired by the acquisition unit 26. In the embodiment, the decision-target vehicle is a vehicle 12 that gives the detection information or the execution information to the information processing device 10 and for which the determination of whether to give the manner point for the action of the vehicle 12 is performed.

When the acquisition unit 26 acquires the detection information, the control unit 28 estimates the action of the decision-target vehicle based on the detection information, and determines whether the estimated action is the other-object influence action. Examples of the action of the decision-target vehicle include the above-described other-object influence action, the manner action and a general traveling action.

The manner action is an action relevant to driving manners other than the other-object influence action, and includes preset actions, as exemplified by a smooth lane change, an appropriate inter-vehicle distance traveling, a congestion notification, an appropriate right-turn preparation, a puddle deceleration and an early lighting. The general traveling action is an action of the vehicle 12 that is other than the other-object influence action and the manner action, and includes actions as exemplified by traffic-light observance. In the estimation of the action of the decision-target vehicle, the control unit 28 may further use the information about the periphery of the decision-target vehicle. The information about the periphery of the decision-target vehicle is acquired from a vehicle 12 in the periphery of the decision-target vehicle.

For example, in the case where the control unit 28 checks, based on the detection information, that there is a vehicle 12 as the other object that waits diagonally forward of the decision-target vehicle, that the decision-target vehicle is in the stop state and that the decision-target vehicle is flashing the head lamp, the control unit 28 estimates that the action of the decision-target vehicle is the right-turn yielding action. The control unit 28 may check that there is a vehicle 12 as the other object that waits diagonally forward of the decision-target vehicle, based on the position information acquired from the decision-target vehicle and the vehicle 12 as the other object, and the road map information.

For example, in the case where the control unit 28 checks, based on the detection information, that the decision-target vehicle is on the near side of a crosswalk with no traffic light, that the decision-target vehicle is in the stop state, and that there is a pedestrian or bicycle at a side of the crosswalk, the control unit 28 estimates that the action of the decision-target vehicle is the crossing allowing action.

For example, in the case where the control unit 28 checks, based on the detection information, that the decision-target vehicle is traveling, that there is a vehicle 12 as the other object that is traveling on an adjacent lane forward of the decision-target vehicle and that wants to perform the lane change, and that the decision-target vehicle is decelerating and is flashing the head lamp, the control unit 28 estimates that the action of the decision-target vehicle is the lane-change allowing action. The control unit 28 may check that there is a vehicle 12 as the other object that is traveling on an adjacent lane forward of the decision-target vehicle and that wants to perform the lane change, based on the position information acquired from each of the decision-target vehicle and the vehicle 12 as the other object, and the road map information.

For example, in the case where the control unit 28 checks, based on the detection information, that a vehicle 12 as the other object waits for a right turn timing diagonally forward of the decision-target vehicle, that the traffic light forward of the decision-target vehicle during traveling is yellow, and that the decision-target vehicle is in the stop state, the control unit 28 estimates that the action of the decision-target vehicle is the yellow-light stop action. The control unit 28 may check that a vehicle 12 as the other object waits for the right turn timing diagonally forward of the decision-target vehicle, based on the position information acquired from each of the decision-target vehicle and the vehicle 12 as the other object, and the road map information.

For example, in the case where the control unit 28 checks, based on the detection information, that there is a vehicle 12 as the other object that is traveling on an adjacent lane rearward of the decision-target vehicle, and that the decision-target vehicle blinks the direction indicator at an appropriate timing, the control unit 28 estimates that the action of the decision-target vehicle is the mischievous lane-change action. The control unit 28 may check that there is a vehicle 12 as the other object that is traveling on an adjacent lane rearward of the decision-target vehicle, based on the position information acquired from each of the decision-target vehicle and the vehicle 12 as the other object, and the road map information.

For example, in the case where the control unit 28 checks, based on the detection information, that there is a vehicle 12 as the other object on the traveling lane forward of the decision-target vehicle, that the vehicle 12 as the other object is traveling at a speed equal to or higher than the allowable speed, and that the decision-target vehicle continues traveling close to the vehicle 12 as the other object, the control unit 28 estimates that the action of the decision-target vehicle is the tailgating-driving action. The control unit 28 may check that there is a vehicle 12 as the other object on the traveling lane forward of the decision-target vehicle, based on the position information acquired from each of the decision-target vehicle and the vehicle 12 as the other object, and the road map information. Further, the control unit 28 may check that the vehicle 12 as the other object is traveling at a speed equal to or higher than the allowable speed, based on the speed information acquired from the vehicle 12 as the other object.

For example, in the case where the control unit 28 checks, based on the detection information, that there is a vehicle 12 as the other object that is traveling straight on an oncoming lane forward of the decision-target vehicle, and that the decision-target vehicle is turning right, the control unit 28 estimates that the action of the decision-target vehicle is the aggressive right-turn action. The control unit 28 may check that there is a vehicle 12 as the other object that is traveling straight on an oncoming lane forward of the decision-target vehicle, based on the position information acquired from each of the decision-target vehicle and the vehicle 12 as the other object, and the road map information.

For example, in the case where the control unit 28 checks, based on the detection information, that there is a vehicle 12 as the other object that is traveling on the traveling lane of the decision-target vehicle rearward of the decision-target vehicle, and that the decision-target vehicle continues traveling at a speed lower than the allowable speed, the control unit 28 estimates that the action of the decision-target vehicle is the mischievous slow-traveling action. The control unit 28 may check that there is a vehicle 12 as the other object that is traveling on the traveling lane of the decision-target vehicle rearward of the decision-target vehicle, based on the position information acquired from each of the decision-target vehicle and the vehicle 12 as the other object, and the road map information.

For example, in the case where the control unit 28 checks, based on the detection information, that there is a vehicle 12 as the other object that is traveling on the traveling lane of the decision-target vehicle rearward of the decision-target vehicle, and that the decision-target vehicle is suddenly decelerating, the control unit 28 estimates that the action of the decision-target vehicle is the mischievous sudden-braking action. The control unit 28 may check that there is a vehicle 12 as the other object that is traveling on the traveling lane of the decision-target vehicle rearward of the decision-target vehicle, based on the position information acquired from each of the decision-target vehicle and the vehicle 12 as the other object, and the road map information.

For example, in the case where the control unit 28 checks, based on the detection information, that the decision-target vehicle goes toward an intersection, that there is a vehicle 12 as the other object that is traveling short of the intersection, and that the decision-target vehicle does not stop at the stop line, the control unit 28 estimates that the action of the decision-target vehicle is the mischievous non-stop action. The control unit 28 may check that there is a vehicle 12 as the other object that is traveling short of the intersection, based on the position information acquired from the vehicle 12 as the other object, and the road map information.

For example, the control unit 28 determines whether a blinking operation of the direction indicator has been performed at a timing appropriate for the speed before the lane change and whether a slow lane change has been performed, based on the direction indicator information, the speed information, the steering information and the time information that are included in the detection information. Furthermore, based on the determination results, the control unit 28 estimates that the action of the decision-target vehicle is a smooth lane change action in which the lane change is smoothly performed.

For example, the control unit 28 determines whether the decision-target vehicle is traveling so as to be away from a front vehicle at an inter-vehicle distance appropriate for the speed, based on the speed information and the distance information that are included in the detection information. Furthermore, based on the determination result, the control unit 28 estimates that the action of the decision-target vehicle is an appropriate inter-vehicle distance traveling action that is a traveling with an inter-vehicle distance appropriate for the speed.

For example, the control unit 28 determines whether the decision-target vehicle has reached the tail end of congestion, based on the image information that is included in the detection information. Further, for example, the control unit 28 determines whether the decision-target vehicle is blinking the hazard lamp, based on the hazard information that is included in the detection information. Furthermore, for example, based on the determination results, the control unit 28 estimates that the action of the decision-target vehicle is a congestion notification action in which the decision-target vehicle notifies a following vehicle that the decision-target vehicle has reached the tail end of congestion.

For example, the control unit 28 determines whether the decision-target vehicle is in the stop state, based on at least one of the speed information and the braking information that are included in the detection information. Further, for example, the control unit 28 determines whether the right turn of the decision-target vehicle is intended, based on the direction indicator information that is included in the detection information. Further, for example, the control unit 28 determines whether the decision-target vehicle is at a position close to the centerline of a road, based on the image information that is included in the detection information. Furthermore, for example, based on the determination results, the control unit 28 estimates that the action of the decision-target vehicle is an appropriate right-turn preparation action in which the decision-target vehicle waits at a position close to the centerline at the time of right turn.

For example, the control unit 28 determines whether there is a puddle at a position toward which the decision-target vehicle travels, based on the image information that is included in the detection information. Further, for example, the control unit 28 determines whether the decision-target vehicle decelerates and travels when passing on the puddle, based on the image information, the time information and the speed information that are included in the detection information. Furthermore, for example, based on the determination results, the control unit 28 estimates that the action of the decision-target vehicle is a puddle deceleration action in which the decision-target vehicle decelerates near the puddle.

For example, the control unit 28 determines whether the illuminance of the periphery of the decision-target vehicle is a threshold or higher, based on the illuminance information that is included in the detection information. Further, for example, the control unit 28 determines whether the decision-target vehicle has lighted the head lamp, based on the head lamp information that is included in the detection information. Furthermore, for example, based on the determination results, the control unit 28 estimates that the action of the decision-target vehicle is an early lighting action in which the head lamp is lighted in the early morning or at dusk.

For example, the control unit 28 determines whether the closest traffic light forward of the decision-target vehicle is green or red, based on the image information that is included in the detection information. Further, for example, the control unit 28 determines whether the decision-target vehicle is traveling or is in the stop state, based on at least one of the braking information and the speed information that are included in the detection information. Furthermore, for example, based on the determination results, the control unit 28 estimates that the action of the decision-target vehicle is traffic-light observance in which the decision-target vehicle travels on green and stops on red.

The control unit 28 determines whether the estimated action of the decision-target vehicle is the other-object influence action. Alternatively, when the acquisition unit 26 acquires the execution information, the control unit 28 determines whether the action of the decision-target vehicle is the other-object influence action.

In the case where the action of the decision-target vehicle is the favorable other-object influence action and where the other object influenced by the other-object influence action is a vehicle 12, the control unit 28 may request an acknowledgment of the other-object influence action, to the vehicle 12. The control unit 28 may identify the vehicle 12 as the other object, based on the information used for determining whether there is the vehicle 12 as the other object and estimating the action of the decision-target vehicle, and may request the acknowledgment. In the case where the control unit 28 acquires the acknowledgment from the vehicle 12 as the other object to which the control unit 28 requests the acknowledgment, the control unit 28 performs the other-object evaluation, using the acknowledgment as later-described information about the periphery of the decision-target vehicle.

In the case where the control unit 28 acquires the acknowledgment from the vehicle 12 as the other object that acquires the request, the control unit 28 may give the manner point to the vehicle 12. The control unit 28 may give the manner point to the vehicle 12 also in the case where an intended action of the vehicle 12 influenced by the other-object influence action is used for the later-described check of the other-object reaction as the information about the periphery to the other-object influence action. For example, the intended action of the vehicle 12 influenced by the other-object influence action is the blinking of the hazard lamp. The manner point to be given to the vehicle 12 as the other object may be lower than the manner point to be given to the decision-target vehicle. For example, as described later, the control unit 28 gives a manner point of +2 points or more to the decision-target vehicle, and gives a manner point of +1 point to the vehicle 12 that returns the acknowledgment.

In the case where the control unit 28 determines that the action of the decision-target vehicle is the other-object influence action, the control unit 28 determines whether the information about the periphery of the decision-target vehicle has been acquired. The information about the periphery is some of the detection information that is acquired from the decision-target vehicle after the control unit 28 determines that the action of the decision-target vehicle is the other-object influence action, and for example, includes the distance information, the image information and the like. Further, the information about the periphery is some of the detection information that is acquired from the vehicle 12 as the other object for the decide-target vehicle after the control unit 28 determines that the action of the decision-target vehicle is the other-object influence action, and for example, includes the image information, the position information and the like. Further, the information about the periphery includes the acknowledgment that is acquired from the vehicle 12 as the other object for the decide-target vehicle after the control unit 28 determines that the action of the decision-target vehicle is the other-object influence action.

In the case where the information about the periphery of the decision-target vehicle has been acquired, the control unit 28 checks the other-object reaction of the other object to the other-object influence action, based on the information about the periphery.

For example, in the case where the control unit 28 estimates that the action of the decision-target vehicle is the right-turn yielding action and acquires the image information (detection information) from the decision-target vehicle after the estimation, the control unit 28 checks the other-object reaction using the image information as the information about the periphery of the decision-target vehicle. For example, in the case where the control unit 28 checks, in the image information, at least that the vehicle 12 as the other object, after waiting for the right turn timing, is turning right, or that the vehicle 12 is blinking the hazard lamp, the control unit 28 recognizes that the reaction of the other object is the other-object reaction indicating affirmation. The other-object reaction indicating the affirmation is a reaction that is likely to be performed when the action of the decision-target vehicle is favorable for the other object.

For example, in the case where the control unit 28 estimates that the action of the decision-target vehicle is the right-turn yielding action and acquires at least the steering information and speed information (detection information), the hazard information or the acknowledgment from the vehicle 12 as the other object after the estimation, the control unit 28 checks the other-object reaction using the acquired information as the information about the periphery of the decision-target vehicle. For example, in the case where the control unit 28 checks that the vehicle 12 as the other object is turning right based on the steering information and the speed information, the control unit 28 recognizes that the reaction of the other object is the other-object reaction indicating the affirmation. For example, in the case where the control unit 28 acquires the hazard information or the acknowledgment, the control unit 28 recognizes that the reaction of the other object is the other-object reaction indicating the affirmation.

For example, in the case where the control unit 28 estimates that the action of the decision-target vehicle is the crossing allowing action and acquires the image information (detection information) from the decision-target vehicle after the estimation, the control unit 28 checks the other-object reaction using the image information as the information about the periphery of the decision-target vehicle. For example, in the case where the control unit 28 checks, in the image information, that a pedestrian or bicycle at a side of the crosswalk is crossing the crosswalk, the control unit 28 recognizes that the reaction of the other object is the other-object reaction indicating the affirmation.

For example, in the case where the control unit 28 estimates that the action of the decision-target vehicle is the lane-change allowing action and acquires the image information (detection information) from the decision-target vehicle after the estimation, the control unit 28 checks the other-object reaction using the image information as the information about the periphery of the decision-target vehicle. For example, in the case where the control unit 28 checks, in the image information, at least that the vehicle 12 as the other object forward of the decision-target vehicle is performing the lane change, or that the vehicle 12 as the other object is blinking the hazard lamp, the control unit 28 recognizes that the reaction of the other object is the other-object reaction indicating the affirmation.

For example, in the case where the control unit 28 estimates that the action of the decision-target vehicle is the lane-change allowing action and acquires at least one of the steering information, the hazard information and the acknowledgment from the vehicle 12 as the other object after the estimation, the control unit 28 checks the other-object reaction using the acquired information as the information about the periphery of the decision-target vehicle. For example, in the case where the control unit 28 checks that the vehicle 12 as the other object is performing the lane change based on the steering information, the control unit 28 recognizes that the reaction of the other object is the other-object reaction indicating the affirmation. For example, in the case where the control unit 28 acquires the hazard information or the acknowledgment, the control unit 28 recognizes that the reaction of the other object is the other-object reaction indicating the affirmation.

For example, in the case where the control unit 28 estimates that the action of the decision-target vehicle is the yellow-light stop action and acquires the image information (detection information) from the decision-target vehicle after the estimation, the control unit 28 checks the other-object reaction using the image information as the information about the periphery of the decision-target vehicle. For example, in the case where the control unit 28 checks, in the image information, at least that the vehicle 12 as the other object, after waiting for the right turn timing, is turning right, or that the vehicle 12 is blinking the hazard lamp, the control unit 28 recognizes that the reaction of the other object is the other-object reaction indicating the affirmation.

For example, in the case where the control unit 28 estimates that the action of the decision-target vehicle is the yellow-light stop action and acquires at least the steering information and speed information (detection information), the hazard information or the acknowledgment from the vehicle 12 as the other object after the estimation, the control unit 28 checks the other-object reaction using the acquired information as the information about the periphery of the decision-target vehicle. For example, in the case where the control unit 28 checks that the vehicle 12 as the other object is turning right based on the steering information and the speed information, the control unit 28 recognizes that the reaction of the other object is the other-object reaction indicating the affirmation. For example, in the case where the control unit 28 acquires the hazard information or the acknowledgment, the control unit 28 recognizes that the reaction of the other object is the other-object reaction indicating the affirmation.

For example, in the case where the control unit 28 estimates that the action of the decision-target vehicle is the mischievous lane-change action and acquires at least one of the image information and the distance information, in addition to the time information (detection information), from the decision-target vehicle after the estimation, the control unit 28 checks the other-object reaction using the acquired information as the information about the periphery of the decision-target vehicle. For example, in the case where the control unit 28 checks that the vehicle 12 as the other object rearward of the decision-target vehicle is decelerating based on pieces of the image information or distance information that are different in acquisition time, the control unit 28 recognizes that the reaction of the other object is the other-object reaction indicating negation. The other-object reaction indicating the negation is a reaction that is likely to be performed when the action of the decision-target vehicle is unfavorable for the other object.

For example, in the case where the control unit 28 estimates that the action of the decision-target vehicle is the mischievous lane-change action and acquires at least one of the braking information and the speed information (detection information) from the vehicle 12 as the other object after the estimation, the control unit 28 checks the other-object reaction using the acquired information as the information about the periphery of the decision-target vehicle. For example, in the case where the control unit 28 checks that the vehicle 12 as the other object is decelerating based on the braking information or the speed information, the control unit 28 recognizes that the reaction of the other object is the other-object reaction indicating the negation.

For example, in the case where the control unit 28 estimates that the action of the decision-target vehicle is the tailgating-driving action and acquires at least one of the image information and the distance information, in addition to the time information (detection information), from the decision-target vehicle after the estimation, the control unit 28 checks the other-object reaction using the acquired information as the information about the periphery of the decision-target vehicle. For example, in the case where the control unit 28 checks that the vehicle 12 as the other object forward of the decision-target vehicle is suddenly accelerating based on pieces of the image information or distance information that are different in acquisition time, the control unit 28 recognizes that the reaction of the other object is the other-object reaction indicating the negation. For example, in the case where the control unit 28 estimates that the vehicle 12 as the other object is performing the lane change based on the image information, the control unit 28 recognizes that the reaction of the other object is the other-object reaction indicating the negation.

For example, in the case where the control unit 28 estimates that the action of the decision-target vehicle is the tailgating-driving action and acquires at least one of the speed information and the steering information (detection information) from the vehicle 12 as the other object after the estimation, the control unit 28 checks the other-object reaction using the acquired information as the information about the periphery of the decision-target vehicle. For example, in the case where the control unit 28 checks that the vehicle 12 as the other object is suddenly accelerating based on the speed information, the control unit 28 recognizes that the reaction of the other object is the other-object reaction indicating the negation. For example, in the case where the control unit 28 estimates that the vehicle 12 as the other object is performing the lane change based on the steering information, the control unit 28 recognizes that the reaction of the other object is the other-object reaction indicating the negation.

For example, in the case where the control unit 28 estimates that the action of the decision-target vehicle is the aggressive right-turn action and acquires the image information and the time information (detection information) from the decision-target vehicle after the estimation, the control unit 28 checks the other-object reaction using the acquired information as the information about the periphery of the decision-target vehicle. For example, in the case where the control unit 28 checks that the vehicle 12 as the other object diagonally forward of the decision-target vehicle is decelerating based on pieces of the image information that are different in acquisition time, the control unit 28 recognizes that the reaction of the other object is the other-object reaction indicating the negation.

For example, in the case where the control unit 28 estimates that the action of the decision-target vehicle is the aggressive right-turn action and acquires at least one of the speed information and the braking information (detection information) from the vehicle 12 as the other object after the estimation, the control unit 28 checks the other-object reaction using the acquired information as the information about the periphery of the decision-target vehicle. For example, in the case where the control unit 28 checks that the vehicle 12 as the other object is decelerating based on at least one of the speed information and the braking information, the control unit 28 recognizes that the reaction of the other object is the other-object reaction indicating the negation.

For example, in the case where the control unit 28 estimates that the action of the decision-target vehicle is the mischievous slow-traveling action and acquires at least one of the image information and the distance information, in addition to the time information (detection information), from the decision-target vehicle after the estimation, the control unit 28 checks the other-object reaction using the acquired information as the information about the periphery of the decision-target vehicle. For example, in the case where the control unit 28 checks that the vehicle 12 as the other object rearward of the decision-target vehicle is approaching the decision-target vehicle based on pieces of the image information or braking information that are different in acquisition time, the control unit 28 recognizes that the reaction of the other object is the other-object reaction indicating the negation.

For example, in the case where the control unit 28 estimates that the action of the decision-target vehicle is the mischievous slow-traveling action and acquires at least one of the image information and the distance information (detection information) from the vehicle 12 as the other object after the estimation, the control unit 28 checks the other-object reaction using the acquired information as the information about the periphery of the decision-target vehicle. For example, in the case where the control unit 28 checks that the vehicle 12 as the other object is approaching the decision-target vehicle based on at least one of the image information and the distance information, the control unit 28 recognizes that the reaction of the other object is the other-object reaction indicating the negation.

For example, in the case where the control unit 28 estimates that the action of the decision-target vehicle is the mischievous sudden-braking action and acquires at least one of the image information and the distance information, in addition to the time information (detection information), from the decision-target vehicle after the estimation, the control unit 28 checks the other-object reaction using the acquired information as the information about the periphery of the decision-target vehicle. For example, in the case where the control unit 28 checks that the vehicle 12 as the other object rearward of the decision-target vehicle is suddenly decelerating based on pieces of the image information or braking information that are different in acquisition time, the control unit 28 recognizes that the reaction of the other object is the other-object reaction indicating the negation.

For example, in the case where the control unit 28 estimates that the action of the decision-target vehicle is the mischievous sudden-braking action and acquires at least one of the braking information and the speed information (detection information) from the vehicle 12 as the other object after the estimation, the control unit 28 checks the other-object reaction using the acquired information as the information about the periphery of the decision-target vehicle. For example, in the case where the control unit 28 checks that the vehicle 12 as the other object is suddenly decelerating based on at least one of the braking information and the speed information, the control unit 28 recognizes that the reaction of the other object is the other-object reaction indicating the negation.

For example, in the case where the control unit 28 estimates that the action of the decision-target vehicle is the mischievous non-stop action and acquires the image information and the time information (detection information) from the decision-target vehicle after the estimation, the control unit 28 checks the other-object reaction using the acquired information as the information about the periphery of the decision-target vehicle. For example, in the case where the control unit 28 checks that the vehicle 12 as the other object traveling short of the intersection is suddenly decelerating based on pieces of the image information that are different in acquisition time, the control unit 28 recognizes that the reaction of the other object is the other-object reaction indicating the negation.

For example, in the case where the control unit 28 estimates that the action of the decision-target vehicle is the mischievous non-stop action and acquires at least one of the braking information and the speed information (detection information) from the vehicle 12 as the other object after the estimation, the control unit 28 checks the other-object reaction using the acquired information as the information about the periphery of the decision-target vehicle. For example, in the case where the control unit 28 checks that the vehicle 12 as the other object is suddenly decelerating based on at least one of the braking information and the speed information, the control unit 28 recognizes that the reaction of the other object is the other-object reaction indicating the negation.

After the check of the other-object reaction, the control unit 28 gives the manner point to the decision-target vehicle, based on the other-object influence action and the checked other-object reaction. In the case where the other-object reaction indicates the affirmation, the control unit 28 may give a positive manner point. In the case where the other-object reaction indicates the negation, the control unit 28 may give a negative manner point. For example, in the case where the other-object reaction indicates the affirmation, the control unit 28 gives a manner point of +3 points, and in the case where the other-object reaction indicates the negation, the control unit 28 gives a manner point of −3 points.

In the case where the control unit 28 cannot check the other-object reaction, for example, because the control unit 28 cannot acquire the information about the periphery of the decision-target vehicle, the control unit 28 may give, to the decision-target vehicle, a manner point lower than a manner point that is given based on the other-object influence action and the checked other-object reaction. For example, in the case where the control unit 28 cannot check the other-object reaction, the control unit 28 gives a manner point of +2 points.

In the case where the control unit 28 determines that the action of the decision-target vehicle is the manner action, the control unit 28 may give, to the decision-target vehicle, a manner point lower than a manner point that is given based on the other-object influence action and the checked other-object reaction. For example, in the case where the control unit 28 determines that the action of the decision-target vehicle is the manner action, the control unit 28 gives a manner point of +2 points.

The control unit 28 may give the manner point to the vehicle 12, by giving the manner point to the in-vehicle information processing device 16. Alternatively, the control unit 28 may give the manner point to the vehicle 12, by adding the manner point to the total value in the manner point information that is stored in the storage unit 27 of the information processing device 10 for each of the vehicles 12.

When each of the vehicles 12 receives the product or service in the shop terminal 13, the control unit 28 may communicate with at least one of the shop terminal 13 and the in-vehicle information processing device 16. For example, in a configuration in which the manner point information is stored in the storage unit 27, the control unit 28 gives the manner point information about the vehicle 12 for which an inquiry is made by the shop terminal 13.

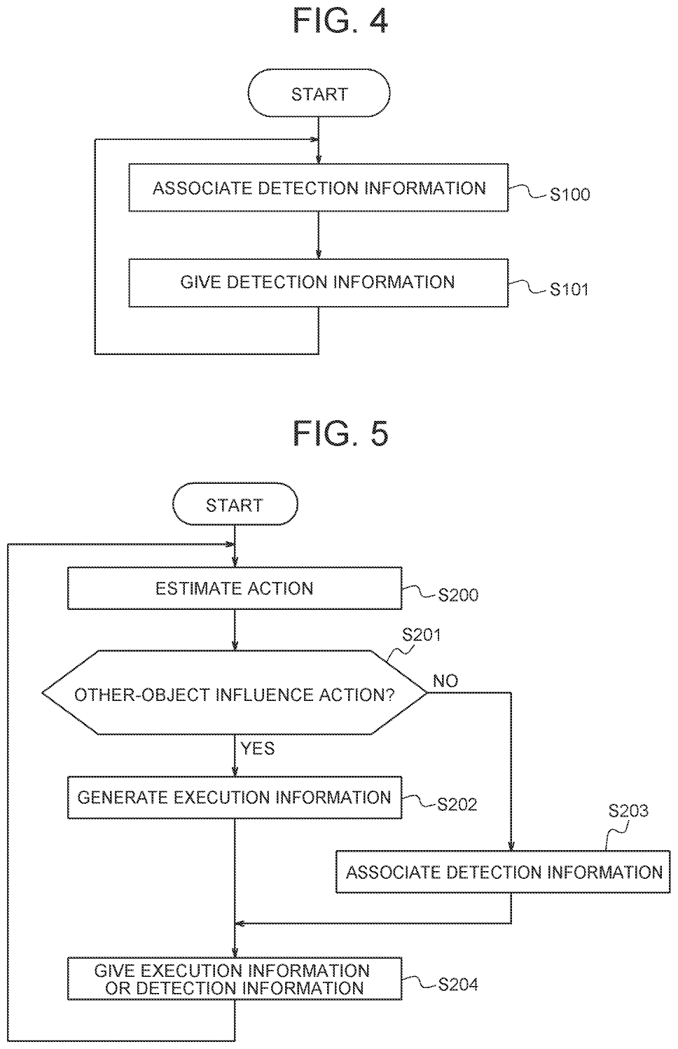

Next, a detection information giving process that is executed by the control unit 25 of the in-vehicle information processing device 16 in the embodiment will be described with use of a flowchart of FIG. 4. The detection information giving process starts whenever the detection information is acquired.

In step S100, the control unit 25 associates the detection information acquired at the same time. After the association, the process proceeds to step S101.

In step S101, the control unit 25 gives the detection information associated in step S100, to the information processing device 10 through the communication device 15. After the giving, the detection information giving process ends.

Next, an execution information giving process that is executed by the control unit 25 of the in-vehicle information processing device 16 in the embodiment will be described with use of a flowchart of FIG. 5. The execution information giving process starts whenever the detection information is acquired.

In step S200, the control unit 25 estimates the action of the own vehicle 12, based on the detection information acquired at the same time. After the estimation of the action, the process proceeds to step S201.

In step S201, the control unit 25 determines whether the action estimated in step S200 is the other-object influence action. In the case where the estimated action is the other-object influence action, the process proceeds to step S202. In the case where the estimated action is not the other-object influence action, the process proceeds to step S203.

In step S202, the control unit 25 generates the execution information indicating that the own vehicle 12 is executing the other-object influence action. After the generation of the execution information, the process proceeds to step S204.

In step S203, the control unit 25 associates the detection information acquired at the same time. After the association, the process proceeds to step S204.

In step S204, the control unit 25 gives the execution information generated in step S202 or the detection information associated in step S203, to the information processing device 10 through the communication device 15. After the sending, the execution information giving process ends.

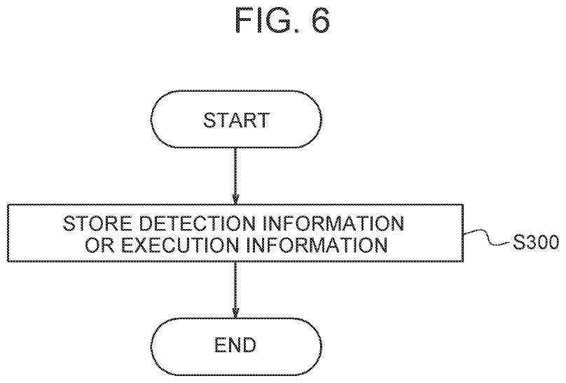

Next, a storage process that is executed by the control unit 28 of the information processing device 10 in the embodiment will be described with use of a flowchart of FIG. 6. The storage process starts whenever the detection information or the execution information is acquired from the in-vehicle information processing device 16.

In step S300, the control unit 28 stores the acquired and associated detection information in the storage unit 27. Alternatively, the control unit 28 stores the acquired execution information in the storage unit 27. After the storage, the storage process ends.

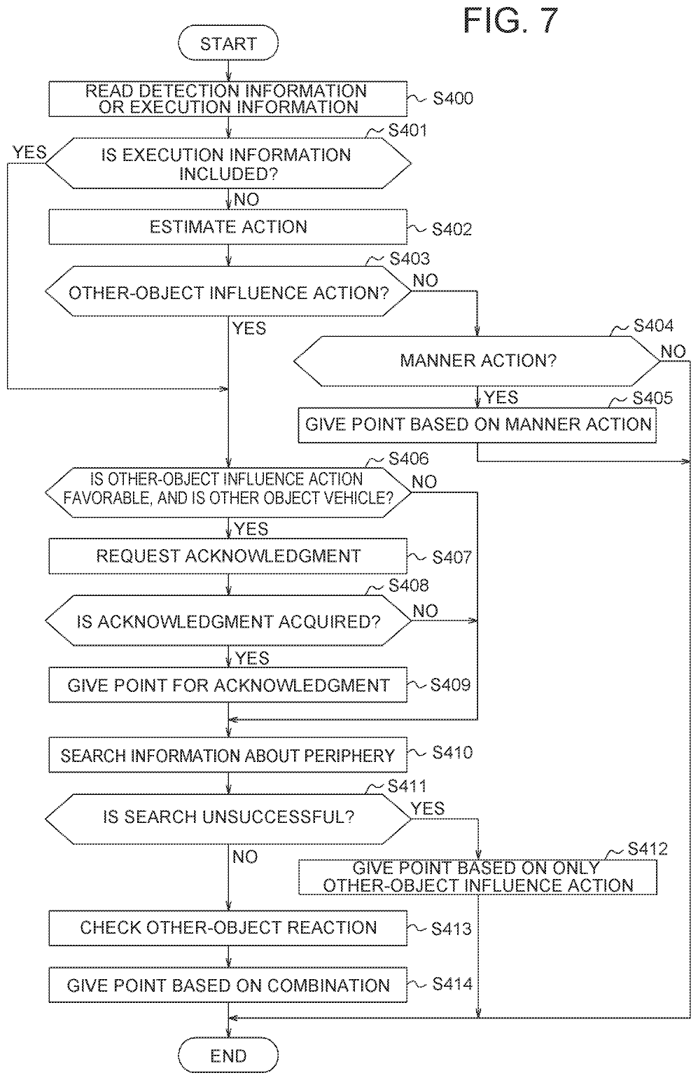

Next, a point giving process that is executed by the control unit 28 of the information processing device 10 in the embodiment will be described with use of a flowchart of FIG. 7. The point giving process starts whenever the detection information or the execution information is acquired from the vehicle 12 other than the decision-target vehicle that is executing the point giving process.

In step S400, the control unit 28 reads the detection information or the execution information from the storage unit 27 in which the information acquired in step S300 of the storage process executed at the same time is stored. After the reading of the detection information or the execution information, the process proceeds to step S401.

In step S401, the control unit 28 determines whether the execution information is included in the information read in step S400. In the case where the execution information is included, the process proceeds to step S406. In the case where the execution information is not included, the process proceeds to step S402.

In step S402, the control unit 28 estimates the action of the decision-target vehicle, based on the detection information read in step S400. After the estimation, the process proceeds to step S403.

In step S403, the control unit 28 determines whether the action of the decision-target vehicle estimated in step S402 is the other-object influence action. In the case where the action of the decision-target vehicle is not the other-object influence action, the process proceeds to step S404. In the case where the action of the decision-target vehicle is the other-object influence action, the process proceeds to step S406.

In step S404, the control unit 28 determines whether the action of the decision-target vehicle estimated in step S402 is the manner action. In the case where the action of the decision-target vehicle is not the manner action, the point giving process ends. In the case where the action of the decision-target vehicle is the manner action, the process proceeds to step S405.

In step S405, the control unit 28 gives the manner point based on the manner action estimated in step S402, to the decision-target vehicle. After the giving of the manner point, the point giving process ends.

In step S406, the control unit 28 determines whether the other-object influence action estimated in step S402 is the favorable other-object influence action and whether the other object in the other-object influence action estimated in step S402 is the vehicle 12 that can communicate with the information processing device 10. In the case where the other-object influence action is not the favorable other-object influence action or the other object is not the vehicle 12 that can communicate with the information processing device 10, the process proceeds to step S410. In the case where the other-object influence action is the favorable other-object influence action and the other object is the vehicle 12 that can communicate with the information processing device 10, the process proceeds to step S407.

In step S407, the control unit 28 requests the acknowledgment of the other-object influence action, to the vehicle 12 that is determined to be able to communicate with the information processing device 10 in step S406. After the request of the acknowledgment, the process proceeds to step S408.

In step S408, the control unit 28 determines whether there is a notice of the acknowledgment from the vehicle 12 to which the acknowledgment has been requested in step S407. In the case where there is not a notice of the acknowledgment, the process proceeds to step S410. In the case where there is a notice of the acknowledgment, the process proceeds to S409.

In step S409, the control unit 28 gives the manner point for the acknowledgment, to the vehicle 12 that has given the notice of the acknowledgment. Further, the control unit 28 stores the acknowledgment in the storage unit 27, as the information about the periphery of the decision-target vehicle. After the giving of the manner point, the process proceeds to step S410.

In step S410, the control unit 28 searches the information about the periphery of the decision-target vehicle at the time of the other-object influence action, in the storage unit 27. After the search, the process proceeds to step S411.

In step S411, the control unit 28 determines whether the search of the information about the periphery is successful. The information about the periphery is the detection information about at least one of the decision-target vehicle and the vehicle 12 as the other object, or the acknowledgment in the notice. The detection information is stored in the storage unit 27 after the reading in the step S400. In the case where the search of the information about the periphery is not successful, the process proceeds to step S412. In the case where the search of the information about the periphery is successful, the process proceeds to step S413.

In step S412, the control unit 28 gives, to the decision-target vehicle, the manner point based on only the other-object influence action estimated in step S402. After the giving of the manner point, the point giving process ends.

In step S413, the control unit 28 checks the other-object reaction based on the information about the periphery searched in step S410. After the check of the other-object reaction, the process proceeds to step S414.

In step S414, the control unit 28 gives, to the decision-target vehicle, the manner point based on combination of the other-object influence action estimated in step S402 and the other-object reaction checked in step S412. After the giving of the manner point, the point giving process ends.

In the case where the thus configured information processing device 10 in the embodiment determines that the action of the decision-target vehicle is the other-object influence action, the information processing device 10 checks the other-object reaction to the other-object influence action, based on the information about the periphery of the decision-target vehicle, and gives the manner point to the decision-target vehicle, based on the other-object influence action and the checked other-object reaction. Generally, as the driving manner, it is particularly desired to execute actions that favorably influence the other object and to avoid actions that unfavorably influence the other object. In the above-described configuration, the information processing device 10 checks the reaction of the other object to the influence that is actually given to the other object, and gives the manner point to the decision-target vehicle, in consideration of the check result. Therefore, the information processing device 10 can encourage the driver to execute particularly desired driving manners. Accordingly, the information processing device 10 improves the technology of encouraging the execution of particularly desired driving manners.

In the case where the information processing device 10 in the embodiment determines that the action of the decision-target vehicle is the favorable other-object influence action and the other object influenced by the other-object influence action is the vehicle 12, the information processing device 10 requests the acknowledgment to the vehicle 12. With this configuration, the information processing device 10 can enhance the certainty of the check of the other-object reaction, using the acknowledgment for directly checking the reaction of the other object. Accordingly, the information processing device 10 can enhance the precision of the estimation of whether the action of the decision-target vehicle is included in particularly desired driving manners, and therefore can further encourage the driver to execute particularly desired driving manners.

The information processing device 10 in the embodiment gives the manner point to the vehicle 12 that has given the notice of the acknowledgment. With this configuration, the information processing device 10 can further encourage the sending of the acknowledgment for directly checking the reaction of the other object. Accordingly, the information processing device 10 can further enhance the precision of the estimation of whether the action of the decision-target vehicle is included in particularly desired driving manners, and therefore can further encourage the driver to execute particularly desired driving manners.

In the case where the information processing device 10 in the embodiment estimates that the action of the decision-target vehicle is the other-object influence action but cannot check the other-object reaction to the decision-target vehicle, and in the case where the action of the decision-target vehicle is merely the manner action, the information processing device 10 gives a manner point lower than a manner point that is given based on the combination of the other-object influence action and the checked other-object reaction. With this configuration, the information processing device 10 appreciates also actions that do not influence the other object, while giving priority to the execution of particularly desired driving manners, and thereby can encourage the driver to improve general driving manners.

In the case where the other-object reaction indicates the negation of the other-object influence action, the information processing device 10 in the embodiment gives a negative manner point to the decision-target vehicle. With this configuration, the information processing device 10 can encourage the driver to avoid other-object influence actions to which the other object has unfavorably reacted. Accordingly, the information processing device 10 can avoid other-object influence actions to which the other object can unfavorably react, and can improve the driving manners.

The disclosure has been described based on the drawings and the embodiment. Note that a person skilled in the art can easily perform various modifications and alterations based on the disclosure. Accordingly, it is should be understood that the modifications and the alterations are included in the scope of the disclosure. For example, functions included in the means, the steps and the like can be rearranged unless there is a logical inconsistency, and a plurality of means, steps and the like may be incorporated to one or may be divided.

For example, in the example described in the embodiment, the communication device 15 is an in-vehicle communication instrument, and the in-vehicle information processing device 16 is a navigation device or automatic driving control device that is mounted on the vehicle 12. However, some or all of the processing operations that are executed by the communication device 15 or the in-vehicle information processing device 16 may be executed by an arbitrary electronic device such as a smartphone or a computer, for example.

For example, in the above-described embodiment, some of the processing operations that are executed in the vehicle 12 may be executed in the information processing device 10, and some of the processing operations that are executed in the information processing device 10 may be executed in the vehicle 12.

For example, a general-purpose electronic device such as a smartphone or a computer can be configured to function as the communication device 15, the in-vehicle information processing device 16 or the information processing device 10 according to the above-described embodiment. Specifically, a program indicating a processing content for realizing each function of the communication device 15 or the like according to the embodiment is stored in a memory of the electronic device, and the program is read and executed by a processor of the electronic device. Therefore, the disclosure according to the embodiment can be realized as a program that can be executed by a processor.

What is claimed is:

1. An information processing device comprising:
an acquisition unit configured to acquire information from a decision-target vehicle; and
a control unit configured to give a manner point to the decision-target vehicle which provides the information, based on an other-object reaction and an other-object influence action, when it is determined that an action of the decision-target vehicle is the other-object influence action based on the acquired information, the other-object influence action being an action that influences another object, the other-object reaction being a reaction of the other object to the other-object influence action and being checked based on information about a periphery of the decision-target vehicle.

2. The information processing device according to claim 1, wherein:
the acquisition unit is configured to acquire detection information detected by a sensor of a vehicle; and
the control unit is configured to estimate the action of the decision-target vehicle based on the detection information, and to determine whether the estimated action is the other-object influence action of the decision-target vehicle.

3. The information processing device according to claim 2, wherein
the control unit is configured to, when it is determined that the action of the decision-target vehicle is the other-object influence action, check the other-object reaction, using detection information acquired from the decision-target vehicle as the information about the periphery.

4. The information processing device according to claim 2, wherein
the control unit is configured to, when it is determined that the action of the decision-target vehicle is the other-object influence action and the other object influenced by the other-object influence action is a vehicle, check the other-object reaction, using detection information acquired from the vehicle being the other object, as the information about the periphery.

5. The information processing device according to claim 1, wherein
the control unit is configured to, when it is determined that the other-object influence action of the decision-target vehicle is a favorable other-object influence action and the other object influenced by the other-object influence action is a vehicle, request an acknowledgment of the other-object influence action, to the vehicle being the other object.

6. The information processing device according to claim 5, wherein
the control unit is configured to check the other-object reaction, using the acknowledgment of the other-object influence action as the information about the periphery, the acknowledgment of the other-object influence action being acquired from the vehicle to which the control unit requests the acknowledgment of the other-object influence action.

7. The information processing device according to claim 5, wherein
the control unit is configured to, when the control unit acquires the acknowledgment of the other-object influence action from the vehicle to which the control unit requests the acknowledgment of the other-object influence action, give the manner point to the vehicle.

8. The information processing device according to claim 1, wherein
the control unit is configured to, when the action of the decision-target vehicle is determined to be the other-object influence action and the control unit is not able to check the other-object reaction, give a manner point lower than a manner point that is given based on the other-object influence action and the other-object reaction, to the decision-target vehicle.

9. The information processing device according to claim 1, wherein
the control unit is configured to, when it is determined that the action of the decision-target vehicle is an action other than the other-object influence action and is a manner action relevant to a driving manner of the decision-target vehicle, give a manner point lower than a manner point that is given based on the other-object influence action and the checked other-object reaction, to the decision-target vehicle.

10. The information processing device according to claim 1, wherein
the control unit is configured to, when the other-object reaction indicates affirmation of the other-object influence action, give a positive manner point.

11. The information processing device according to claim 1, wherein
the control unit is configured to, when the other-object reaction indicates negation of the other-object influence action, give a negative manner point.

12. The information processing device according to claim 1, wherein:
the acquisition unit is configured to acquire execution information indicating that the decision-target vehicle is executing the other-object influence action; and
the control unit is configured to determine that the action of the decision-target vehicle is the other-object influence action, based on the execution information.

13. A non-transitory storage medium in which a program is recorded, wherein when the program is executed by an information processing device, the program causes the information processing device to execute:
acquiring information from a decision-target vehicle;
checking an other-object reaction based on information about a periphery of the decision-target vehicle, when it is determined that an action of the decision-target vehicle is an other-object influence action based on the acquired information, the other-object influence action being an action that influences another object, the other-object reaction being a reaction of the other object to the other-object influence action; and
giving a manner point to the decision-target vehicle based on the other-object influence action and the other-object reaction.

14. An information processing method comprising:
acquiring information from a decision-target vehicle;
checking an other-object reaction based on information about a periphery of the decision-target vehicle, when it is determined that an action of the decision-target vehicle is an other-object influence action based on the acquired information, the other-object influence action being an action that influences another object, the other-object reaction being a reaction of the other object to the other-object influence action; and
giving a manner point to the decision-target vehicle based on the other-object influence action and the other-object reaction.
